(19) United States
(12) Patent Application Publication
(10) Pub. No.: US 2013/0180666 A1
(43) Pub. Date: Jul. 18, 2013

(54) ROLLER SHADE COUNTER BALANCING AND BLIND ATTACHING METHOD AND APPARATUS

(71) Applicants: Willis Jay Mullet, Gulf Breeze, FL (US); Darrin W. Brunk, Pensacola, FL (US); Richard Scott Hand, Pace, FL (US); Harry Edward Asbury, Holt, FL (US)

(72) Inventors: Willis Jay Mullet, Gulf Breeze, FL (US); Darrin W. Brunk, Pensacola, FL (US); Richard Scott Hand, Pace, FL (US); Harry Edward Asbury, Holt, FL (US)

(73) Assignee: HomeRun Holdings Corporation, Pensacola, FL (US)

(21) Appl. No.: 13/353,055

(22) Filed: Jan. 18, 2012

(51) Int. Cl. E06B 9/44; B23P 11/00; E06B 9/50

(52) U.S. Cl. 160/23.1; 160/323.1; 29/428

(57) ABSTRACT

A roller shade is provided. In some embodiments, the roller shade may include: a roller assembly; an inner portion of the roller assembly having an attaching structure for attaching to a mount; an outer portion of the roller assembly located on the roller assembly radially outward from the inner portion; a slot in the outer portion; and an insert dimensioned to be slidably received into the slot along with a portion of a shade to thereby attach the shade to the roller assembly. A method of attaching a shade to a roller assembly may also be provided.

### FIELD OF THE INVENTION

The present invention relates generally to roller shades. More particularly, the present invention relates to an apparatus for attaching shade material to the roller assembly and counter balancing the roller assembly.

### BACKGROUND OF THE INVENTION

Roller shades or blinds have long been used as window coverings. The roller shades may be mounted to the top of windows or above the windows. The window shades may be pulled down over the window to block out unwanted light and/or to provide privacy. Often the roller in the roller shade assembly is spring loaded and may have a pawl or similar system so that the roller shade can be pulled down and stopped at a desired position. In order to roll the shade back up, the shade is slightly pulled down by user to disengage the pawl. Then, the spring system turns the roller thereby rolling the shade or blind material around the roller as the shade or blind retracts. Like anything that rotates on an axis, it may be desirable to balance the roller assembly as it rotates in order to avoid excessive noise, vibration, or other undesirable characteristics resulting from rotating an unbalanced object. Further, the higher the speed of rotation, the more a balanced roller will help to prevent undesirable vibration and noise.

In addition to counter balancing or balancing the roller shade, another desired characteristic is to attach the shade material to the roller assembly. In many current roller assemblies, the shade material is flat and sheet-like. The shade is often simply glued into the roller assembly. While this may be effective in allowing the shade material to be attached to the roller assembly, it can also provide undesired characteristics.

For example, it may be difficult to separate the shade material from the roller assembly. It may be desirable to separate the shade material from the roller assembly in order to clean the shade material, provide maintenance on the roller assembly or to switch out a shade material of one type of material to substitute another type of material. In prior art systems where shade material is simply glued to the roller, detaching and reattaching shade material to the roller assembly may be problematic and often not feasible. Thus, in some prior art systems, rather than removing the shade material from the roller assembly, different shade material is used or substituted by removing both the shade material and the roller assembly and replacing it with a second shade material attached to a second roller assembly. With respect to cleaning and maintenance of the shade material, this must be done carefully while the shade material is still attached to the roller assembly.

In order to help solve or mitigate the draw backs of some of the prior art described above, it may be desirable to have a new apparatus or method in the field of shade material and roller assemblies.

### SUMMARY OF THE INVENTION

The foregoing needs are met, to a great extent, by some embodiments of the present invention. Wherein in one aspect, an apparatus is provided that, in some embodiments, in order to reduce or mitigate some of the short comings or problems set forth above, a new method and apparatus for assembling a shade material is provided.

In accordance with one embodiment of the present invention, a roller shade is provided. In some embodiments, the roller shade may include: a roller assembly; an inner portion of the roller assembly having an attaching structure for attaching to a mount; an outer portion of the roller assembly located on the roller assembly radially outward from the inner portion; a slot in the outer portion; and an insert dimensioned to be slidably received into the slot along with a portion of a shade to thereby attach the shade to the roller assembly.

In accordance with another embodiment of the present invention, a method of attaching a shade to a roller assembly is provided. The method may include: forming an outer portion of the roller assembly with a sufficient thickness to support an attaching grove in the outer portion; forming an attaching groove in the outer portion; and providing an attaching insert dimensioned to slide along with a portion of a shade material into the slot to trap the shade material between the insert and the slot.

In accordance with yet another embodiment of the present invention, a roller shade may be provided. The roller shade may include: a roller assembly; an inner portion of the roller assembly having an attaching structure for attaching to a mount; an outer portion of the roller assembly located on the roller assembly radially outward from the inner portion; a means for receiving a counterbalance weight in the outer portion; and a removable means for counter balancing the roller assembly dimensioned to be slidably received into the receiving means.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a blind assembly 10 in accordance with an embodiment of the invention.

FIG. 2 is an exploded view of a blind assembly as set forth in FIG. 1.

FIG. 3 is an end view of a roller assembly and blind material attached to the roller assembly.

FIG. 4 is a partial end view of the roller assembly and blind material.

FIG. 5 is a partial end view of another portion of the roller assembly and blind material.

FIG. 6 is a perspective view showing different types of inserts that may be used in accordance with an embodiment of the invention.

FIG. 7 is an end view of a roller assembly in accordance with another embodiment of the invention.

### DETAILED DESCRIPTION

The invention will now be described with reference to the drawing figures, in which like reference numerals refer to like parts throughout. An embodiment in accordance with the present invention provides a method and apparatus for attaching blind or shade material to a roller assembly. Further, a method and apparatus is also shown and described that may be used to counter balance a roller assembly.

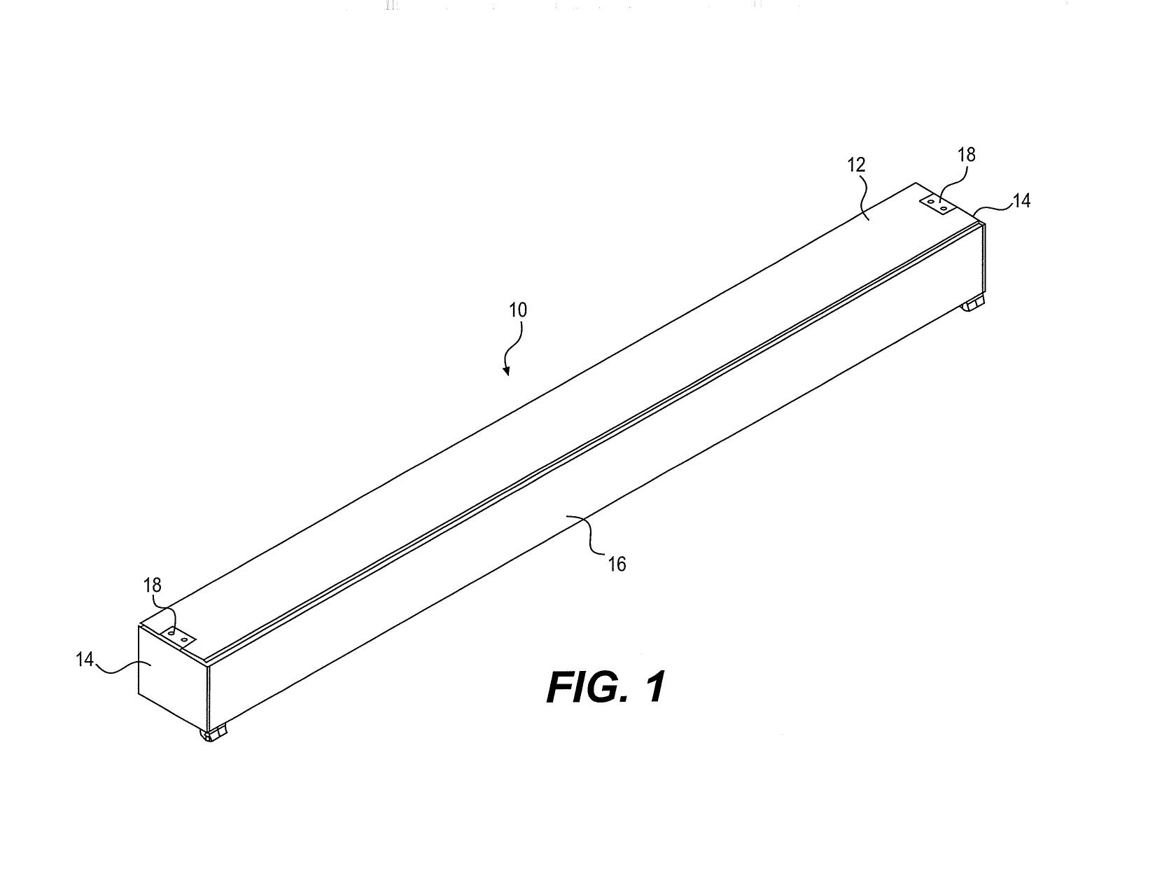

FIG. 1 illustrates a blind assembly 10 that may be used in accordance with some embodiments of the invention. The blind assembly 10 includes a header housing 12, end caps 14 and a cover 16. The end caps 14 may be attached to the header housing 12 via brackets 18. The cover 16 may be attached to the end caps 14 by brackets that are hidden in the view of FIG. 1 and contained within the blind assembly 10. In other embodiments of the invention, other types of brackets or other attaching means may be used to attach the header housing 12, end caps 14 and the cover 16.

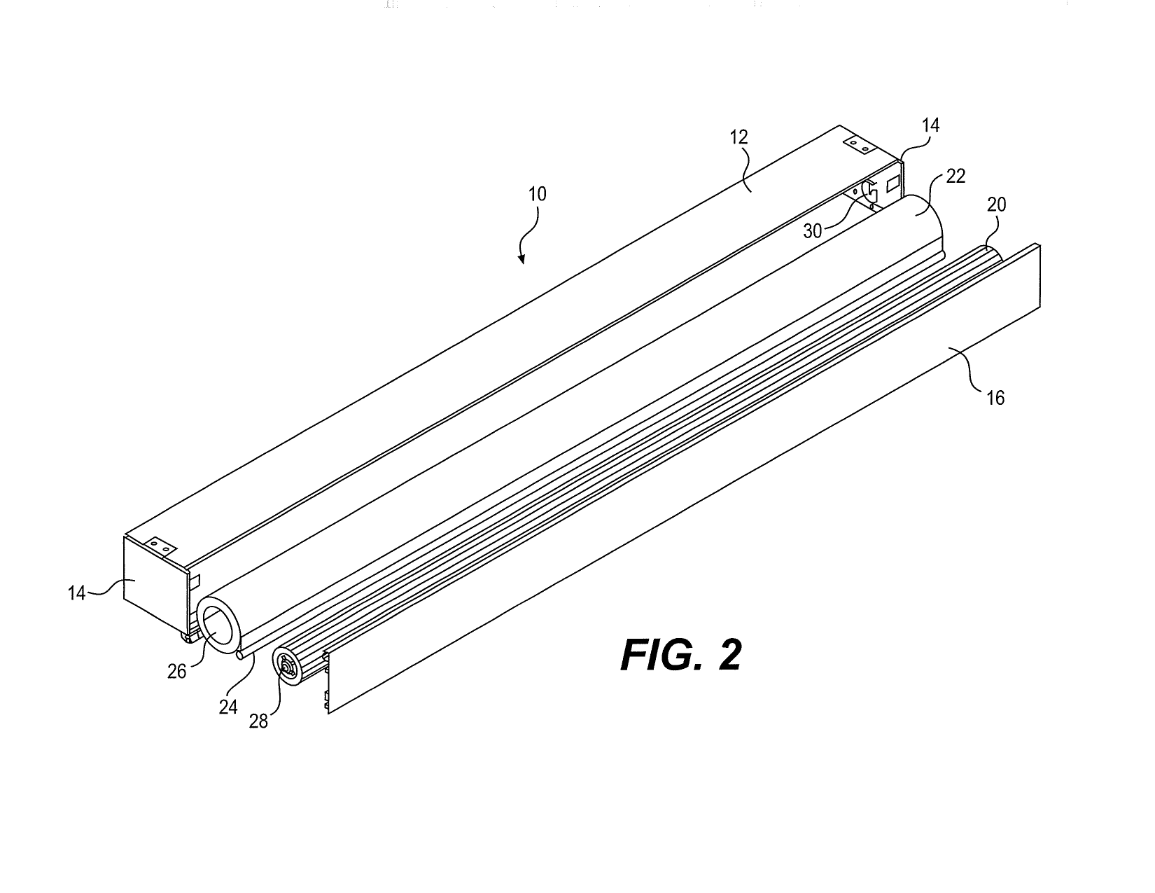

FIG. 2 is a perspective exploded view of the blind assembly 10 shown in FIG. 1. As shown, in FIG. 2, the blind assembly 10 includes the header housing 12, the end caps 14 and the cover 16. A roller assembly 20 is located within the header housing 12, the end caps 14 and the cover 16. Normally, the blind material 22 or shade material 22 is wrapped around the roller assembly 20. However, in the exploded view in FIG. 2, the blind material 22 or shade material 22 is shown wrapped around itself forming a roll but is not wrapped around the roller assembly 20 to better illustrate the roller assembly 20.

The blind or shade material 22 is terminated at one end by a rail 24. The rail 24 has larger diameter than the blind or shade material 22 and allows a user to grasp the rail 24 as a handle. In other embodiments of the invention, a pull cord may be attached to the blind material 22. The blind material 22 as shown in FIG. 2 has a hole 26 or void contained within it. Normally, the roller assembly 20 is located in the void 26, as the blind material 22 is normally wrapped around the roller assembly 20.

The roller assembly 20 includes an axle 28 located at about the center of rotation for the roller assembly 20 and the blind material 22. The axle 28 fits into a bracket 30 located on or near one or both end caps 14. In some embodiments the brackets 30 may be attached to a wall or other structure above a window to which the blind assembly 10 may also be attached. The roller bracket 30 permits the axle 28 to rotate while securing the roller assembly 20 and blind material within the blind assembly 10.

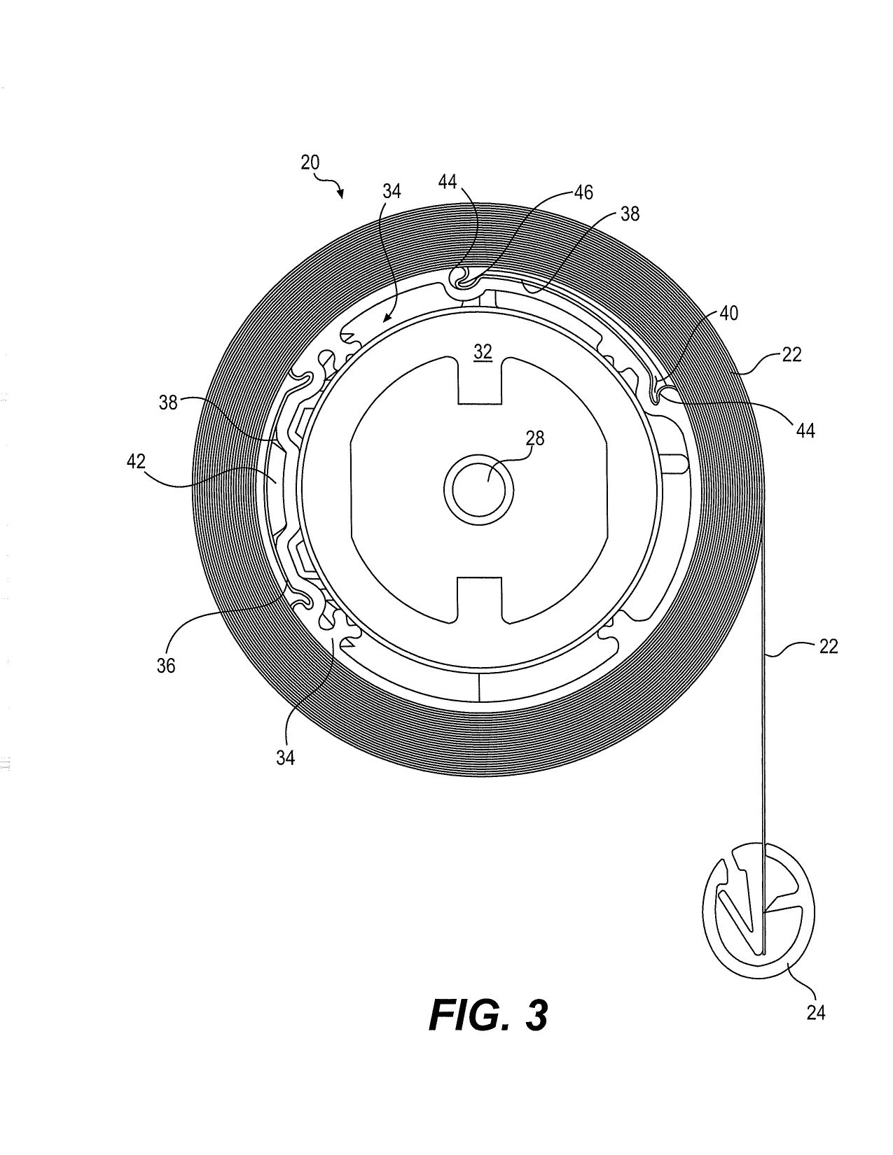

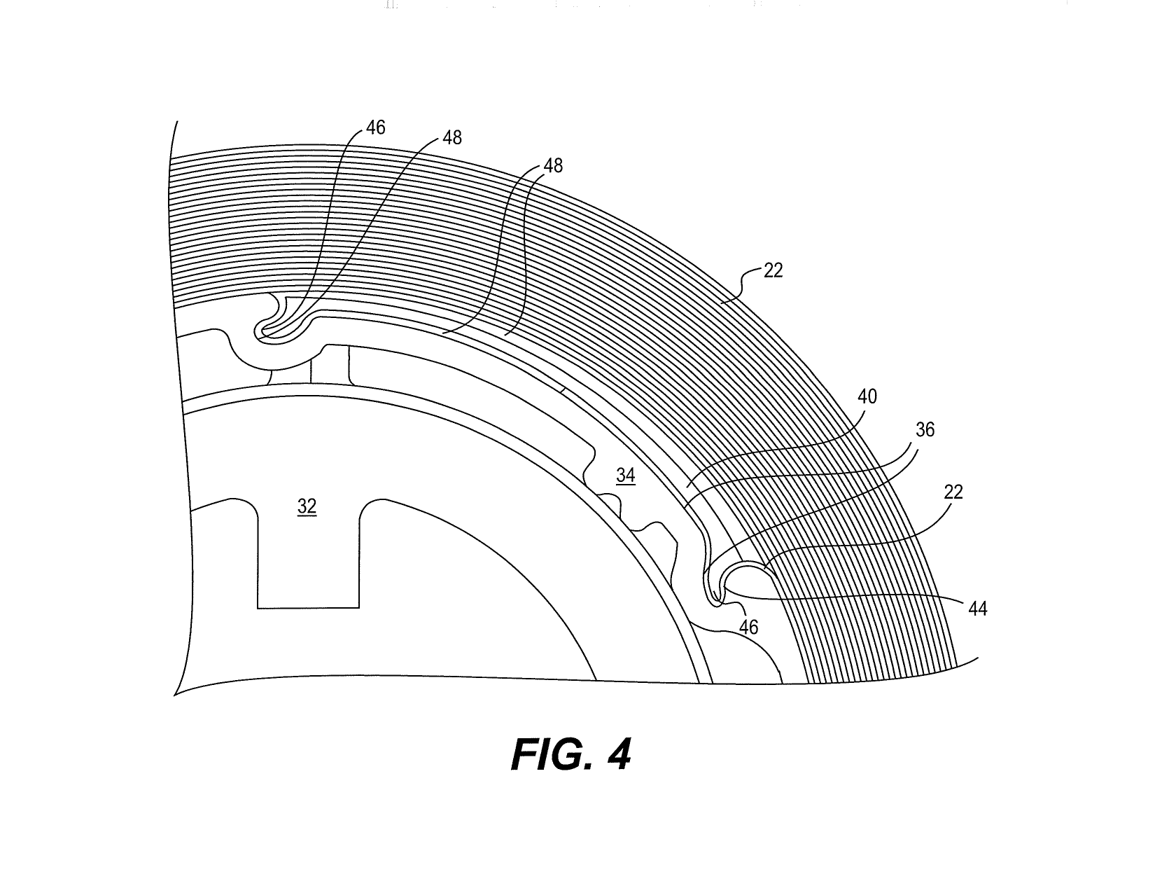

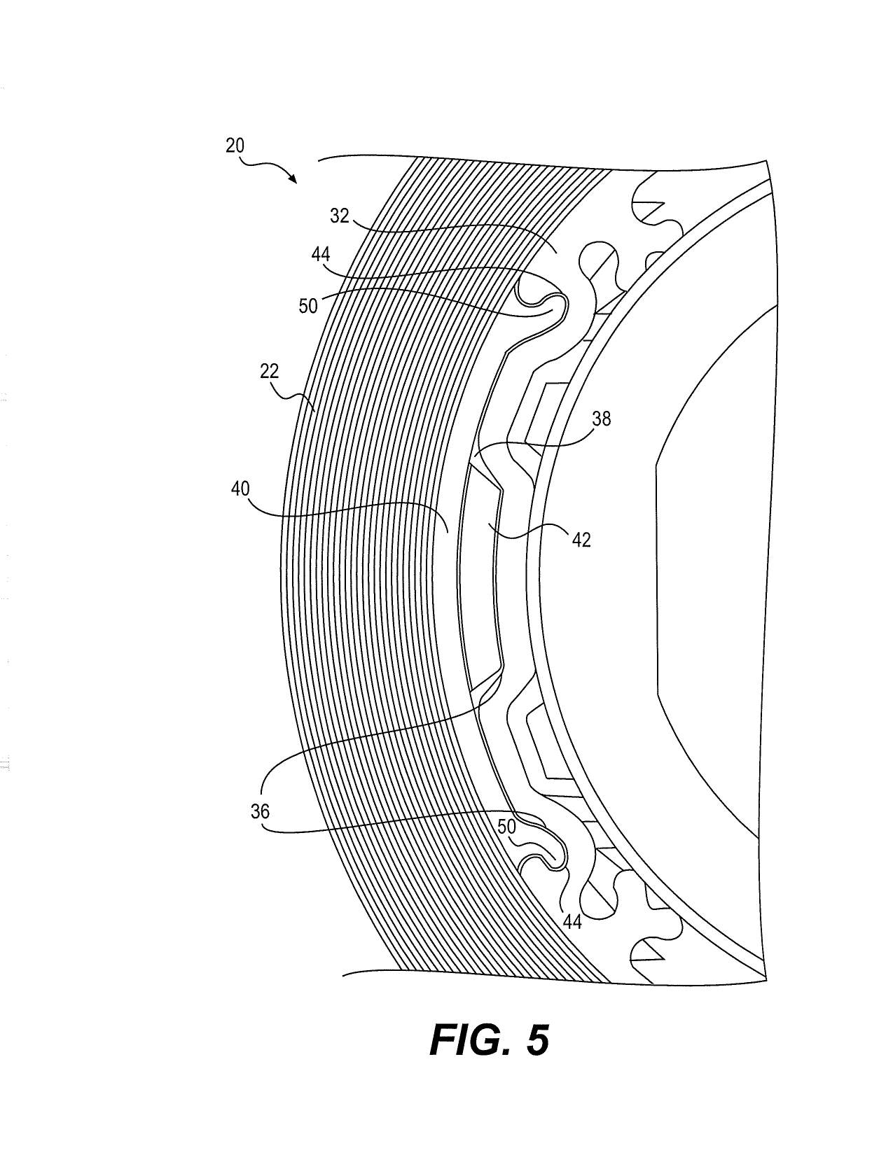

FIG. 3 is a an end view of the roller assembly 20 and blind material 22. FIGS. 4 and 5 are enlarged, partial end views of part of the roller assembly 20 and blind material 22. The following description will be made with reference characters that may be found in one or more of FIGS. 3-5.

The roller assembly 20 includes an inner roller assembly 32 and an outer roller assembly 34. The inner roller assembly 32 includes the axle 28.

In some embodiments of the invention, the axle 28 may extend all the way through the inner roller assembly 32 to project out at both ends of the inner roller assembly 32.

In other embodiments of the invention, the axle 28 may be a pair of trunnions that project out of either end of the inner roller assembly 32 without extending through the inner roller assembly 32.

It would be understood by one of ordinary skill in the art that the inner roller assembly 32 may contain a spring mechanism and pawl mechanism or other mechanism to allow the roller assembly 20 to be stopped in various positions as is commonly known in the roller shade art. A description of these assemblies will not be described here as they are well known.

The outer roller assembly 34 may include various curved surfaces 36. These curved surfaces 36 may define voids or slots 38. The voids or slots 38 may extend along the length of the outer roller assembly 34 and provide a space for an attaching insert 40 to be slide into the void or slot 38.

Attaching the blind material 22 to the roller assembly 20 is accomplished in some embodiments of the invention and as best shown in FIG. 4. Part of the blind material 22 may be wrapped partially around the attaching insert 40. The attaching insert 40 and the blind material 22 are slid into the void or slot 38, thus trapping part of the blind material 22 between the attaching insert 40 and the outer roller assembly 34.

The voids or slots 38 may include channels 44 that are dimensioned to allow the protrusions 46 on the attaching insert 40 to slide along some of the blind material 22 into the channels 44. The geometry of the channels 44 and the protrusions 46 allow the attaching insert 40 to be retained within the outer roller assembly 34, and resist the centrifugal force generated by the outer roller assembly 34 is rotating. Because the attaching insert 40 can slide in and out of the voids or slots 38, the attaching system shown in FIGS. 3-5 allows blind material 22 to be selectively attached or detached to the roller assembly 20. Thus, the blind material 22 can be removed for cleaning or be changed out for a different blind material as desired. One of ordinary skill in the art after reviewing this disclosure, would appreciate that in order to attach or remove the blind material 22 from the roller assembly 20, the roller assembly 20 must be removed from the bracket 30 and the blind assembly 10. The blind material 22 is removed from the roller assembly 20 for cleaning or replacement. Once the blind material 22 is installed back on the roller assembly 20, the roller assembly 20, the roller assembly 20 may be reinstalled back into the blind assembly 10.

FIG. 4 also shows that a gap 48 may be generated between the attaching insert 40 and the voids or slots 38 defined by the outer roller assembly 34. The gap 48 may form where the blind material 22 is absent. It will be appreciated by one of ordinary skill in the art after reviewing this disclosure that the voids or slots 38 will be dimensioned so that even with the attaching insert 40 and some of the blind material 22 located in the void or slot 38, that the gap 38 may also be formed between the attaching insert 40 and blind material 22 as shown in FIG. 4.

The attaching insert 40 and the blind material 22 may be countersunk to a position below the rest of the outer roller assembly 34. This countersinking may assist in reducing the likelihood of forming protrusions or other anomalies in the neatly rolled up blind material 22. Keeping the blind material 22 in neat rolls may assist in allowing the roller shade assembly 20 to not vibrate, chatter or otherwise make noise as it is being manipulated.

As shown in FIGS. 3-5, additional attaching inserts 40 may be present in the outer roller assembly 34 even if they are not providing the function of attaching the blind material 22 to the roller assembly 20. Having multiple attaching inserts 40 will provide a user with various options of where to attach the blind material 22 to the roller assembly 20. Further, attaching inserts 40 not used for attaching the blind material 20 to the roller assembly 20 may be added or removed to provide desired counterbalancing. In addition to using the attaching inserts 40 for the purpose of counterbalancing, weights or inserts 42 may also be placed within void 38 or slots 38 to counterbalance the roller assembly 20.

As shown in FIG. 5, the dynamic counter balance inserts or weights 42 may have a geometry that corresponds to the void or slot 38 in which they reside. These counter balance inserts 42 may be slid longitudinally into or removed out of the voids 38 in order to provide a desired amount of counterbalancing.

In some embodiments of the invention, the outer wall assembly 34 may define several slots or voids 38 into which attaching inserts 40 or counterbalancing weights or inserts 42 may be placed to provide desired counterbalancing. In some embodiments of the invention, combinations of attaching inserts 40 and counterbalancing inserts 42 may be moved, removed or inserted in order to provide the desired amount of counterbalancing.

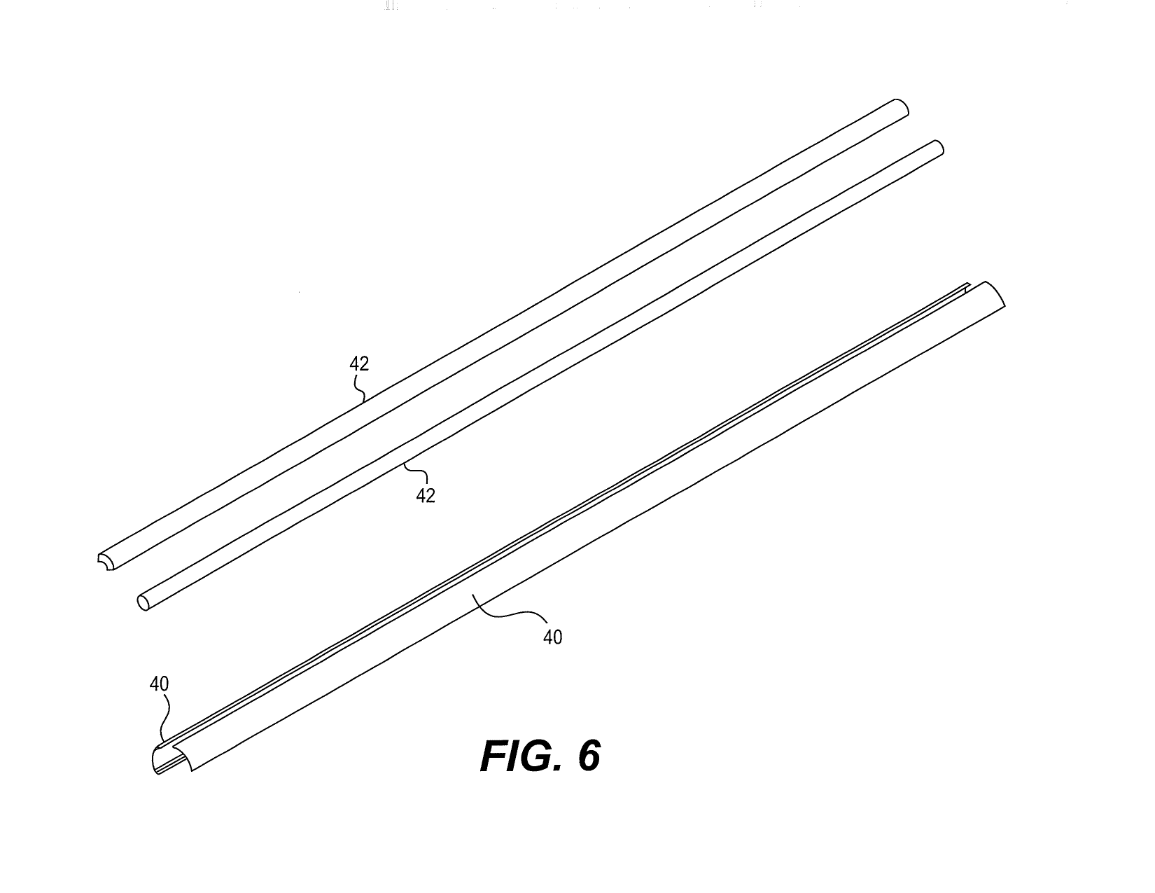

FIG. 6 shows examples of various inserts 40 and 42 that may be inserted into the outer roller assembly 34 to provide various functions. The attaching inserts 40 perform an attaching function or to provide a counterbalancing function. The counterbalance insert 42 may perform a counterbalance function. Counterbalancing can also be achieved by additional removal of the attaching inserts 40 that are not used in the attaching function. As shown in FIG. 6, the inserts 42 may have a variety of cross-sectional geometries. The inserts 42 as shown in FIG. 6 are meant to be exemplary and are in no way limiting.

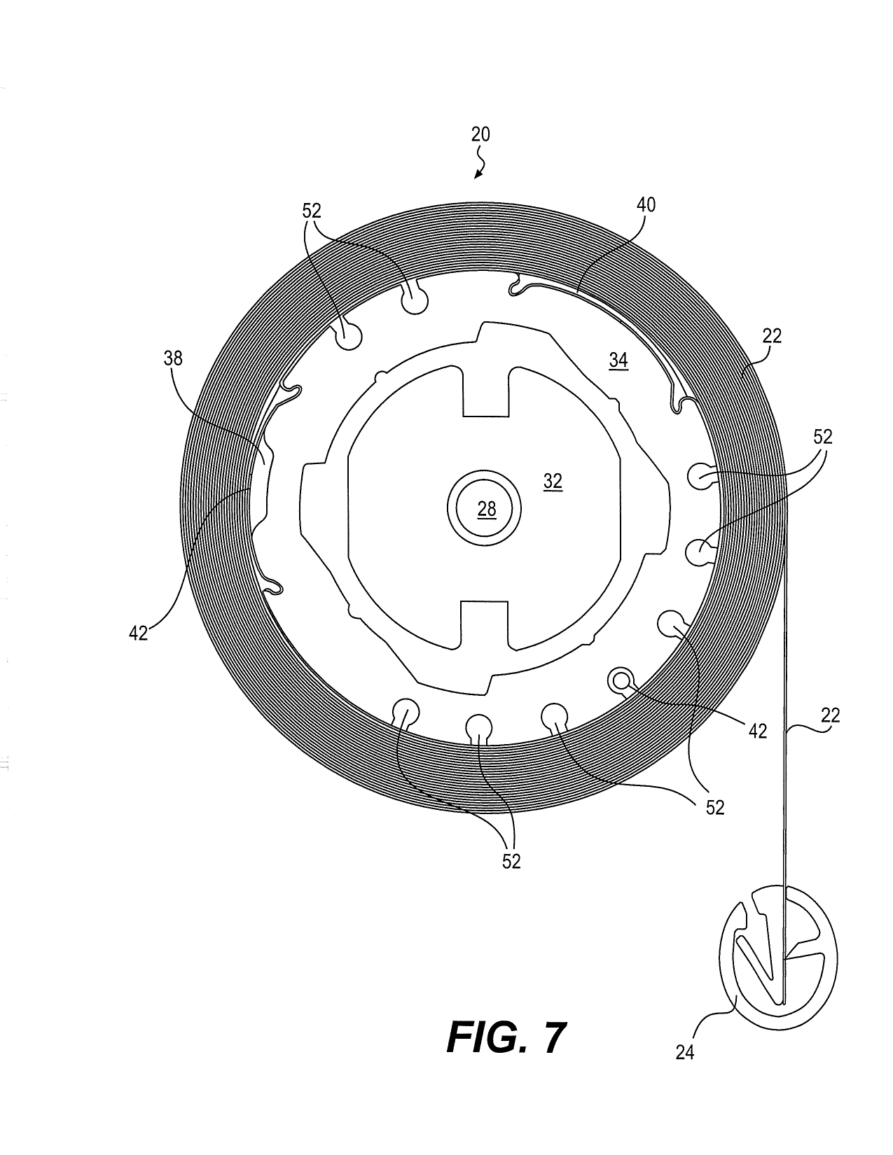

FIG. 7 shows a side view of a roller assembly in accordance with another embodiment of the invention. Similar to the embodiment described above, the embodiment shown in FIG. 7 includes an inner roller assembly 32, an axle 28 and an outer roller assembly 34. The outer roller assembly 34 is sufficiently thick enough to be able to define void or slots 38 in addition to rounded voids 52. The rounded slots 52 are located at various locations allowing a user to, by trial and error, place a rounded insert 42 into various slots 52 in order to find the best location for the counterbalancing insert 42 in order to left counterbalance the lower assembly 20.

As shown in FIG. 7, the roller assembly 20 also includes the attaching insert 40 and other counterbalancing inserts 42. The roller material 22 is partially wrapped around the roller assembly 20 and partially extends down and is terminated with a rail 24.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A roller shade comprising:
a roller assembly;
a inner portion of the roller assembly having an attaching structure for attaching to a mount;
an outer portion of the roller assembly located on the roller assembly radially outward from the inner portion;
a slot in the outer portion; and
an insert dimensioned to be slidably received into the slot along with a portion of a shade to thereby attach the shade to the roller assembly.

2. The roller shade of claim 1, wherein the slot and the insert are dimensioned such that when the insert is in the slot, the insert and slot are countersunk with respect to the surrounding outer portion in which the slot resides.

3. The roller shade of claim 1, further comprising an additional slot in the outer portion and an additional insert that is dimensioned to fit into the additional slot.

4. The roller shade of claim 3, further comprising more than one additional slots.

5. The roller shade of claim 3, wherein the additional insert is shaped like a cylinder.

6. The roller shade of claim 1, wherein the insert is shaped like a cylinder.

7. The roller shade of claim 1, wherein the slot has at least one channel and the insert has at least one protrusion dimensioned to fit within the channel.

8. The roller shade of claim 1, wherein a portion of the shade fits under a portion of the insert and around one side of the insert when the insert is in the slot.

10. The roller shade of claim 1, further including an axle on the inner portion of the roller assembly and a bracket dimensioned to support the axle.

11. The roller shade of claim 10, further comprising:
a header housing located over the roller assembly; and
a cover and end caps together with the header housing encompassing at least part of the roller assembly.

12. The roller shade of claim 1, further comprising a rail located on the shade on an end of the shade opposite an end of the shade that attached to the roller assembly.

13. The roller shade of claim 1, wherein the insert and the slot are dimensioned to allow the insert to be removed by sliding the insert longitudely out of the slot to permit the shade to be removed and be at least one of: reinstalled and replaced, when the insert is slid back in place with one of the shade material or a new shade material.

14. A method of attaching a shade to a roller assembly comprising:
forming an outer portion of the roller assembly with a sufficient thickness to support an attaching grove in the outer portion;
forming an attaching groove in the outer portion; and
providing an attaching insert dimensioned to slide along with a portion of a shade material into the slot to trap the shade material between the insert and the slot.

15. The method of claim 14, further comprising providing at least one additional groove in the outer portion and at least one additional insert.

16. The method of claim 15, wherein the at least one additional groove and at least one additional insert define a substantially circular cross section.

17. The method of claim 14, further comprising forming a channel in the slot and a protrusion on the insert dimensioned to slide longitudinally in the channel.

18. The method of claim 14, further comprising configuring the slot and insert to allow the insert to slide in and out of the slot to allow shade material to selectively attached to and detached from the roller assembly.

19. A roller shade comprising:
a roller assembly;
an inner portion of the roller assembly having an attaching structure for attaching to a mount;
an outer portion of the roller assembly located on the roller assembly radially outward from the inner portion;
means for receiving a counterbalance weight in the outer portion; and
a removable means for counter balancing the roller assembly dimensioned to be slidably received into the receiving means.

20. The roller shade of claim 19, further comprising:
an attaching slot in the roller assembly; and
an insert dimensioned to slide into the attaching slot alone with a portion of a shade material to trap the shade material between the insert and the slot to attach the shade material to the roller assembly thereby.
